(19) United States
(12) Patent Application Publication
(10) Pub. No.: US 2026/0354408 A1
(43) Pub. Date: Nov. 12, 2026

(54) FROZEN CONFECTION PRODUCT

(71) Applicants: Cargill, incorporated, Wayzata, MN (US); CUBIQ FOODS, S.L., Ganollers (ES)

(72) Inventors: Regina DRAPER, Minnetonka, MN (US); Diliara IASSONOVA, Maple Grove, MN (US); Raquel REVILLA SANCHEZ, Granollers (ES)

(73) Assignees: Cargill, incorporated, Wayzata, MN (US); CUBIQ FOODS, S.L., Granollers (ES)

(21) Appl. No.: 19/486,138

(22) PCT Filed: Apr. 30, 2024
(86) PCT No.: PCT/US2024/027018

§ 371 Date: Nov. 20, 2025

Related U.S. Application Data
(60) Provisional application No. 63/504,085, filed on May 24, 2023.

(51) Int. Cl. A23G 9/04; A23G 9/32; A23G 9/34; A23G 9/38; A23G 9/42; A23L 29/10

(52) U.S. Cl. CPC A23G 9/04; A23G 9/327; A23G 9/34; A23G 9/38; A23G 9/42; A23L 29/10; A23G 2200/06; A23G 2200/10; A23G 2200/14

(57) ABSTRACT

The present invention relates to a frozen confection product product comprising plant protein, sweetener, emulsifier, stabilizer and an oil in water emulsion, wherein the oil in water emulsion is comprising a plant protein and one or more hydrocolloids and a lipid phase in a water phase. It further relates to the process for preparing the frozen confection product and the use of an oil in water emulsion to reduce the saturated fat content of a frozen confection product.

### CROSS-REFERENCE TO RELATED APPLICATIONS

This application claims the benefit of U.S. Provisional Application No. 63/504,085, filed May 24, 2023, which is hereby incorporated by reference in its entirety.

### FIELD OF THE INVENTION

The present invention relates to a frozen confection product, and a process for preparing it.

### BACKGROUND OF THE INVENTION

Frozen dairy dessert products such as ice cream, ice milk, milk shakes, sherbet, yogurt, sorbet and the aerated versions thereof, are popular due to their convenience, widespread availability, nutritive value and appealing forms, flavors, and colors.

A weight conscious society has further popularized non-fat and low-fat preparations, while consumer expectations such as flavor, appearance, and in particular the physical properties of aerated frozen dessert products remain high priority.

The combination of rigid consumer acceptance criteria, regulatory standards and the complex nature of the interactions which produce an acceptable frozen dessert product, make it difficult to formulate an aerated frozen dessert having improved characteristics, particularly when formulating a reduced or non-fat product containing only natural components and ingredients.

The foregoing factors are also true for frozen dairy dessert products such as ice cream bars, dessert bars, yogurt bars, ice milk bars, fudge pops and the like.

There is thus still a need in the industry for frozen confection product reduced saturated fat content while maintaining or improving the textural and/or sensorial properties. The present invention provides such a product.

### SUMMARY OF THE INVENTION

The present invention relates to a frozen confection product comprising plant protein, sweetener, emulsifier, stabilizer and fat, and the fat is consisting of an oil in water emulsion, wherein the oil in water emulsion is comprising a protein and one or more hydrocolloids and a lipid phase in a water phase.

It relates to a frozen confection product prepared by adding an oil in water emulsion to frozen confection product ingredients and wherein the oil in water emulsion is comprising a plant protein and one or more hydrocolloids and a lipid phase in a water phase.

It describes a process for preparing the frozen confection product of the present invention and the process is comprising:
Blending oil in water emulsion with frozen confection product ingredients,
Freezing the blend, and

Wherein the oil in water emulsion is comprising a plant protein and one or more hydrocolloids and a lipid phase in a water phase.

It further relates to the use of an oil in water emulsion to reduce the saturated fat content of a frozen confection product, and wherein the oil in water emulsion is comprising a plant protein and one or more hydrocolloids and a lipid phase in a water phase.

### DETAILED DESCRIPTION

The present invention relates to a frozen confection product comprising plant protein, sweetener, emulsifier, stabilizer and fat, and the fat is consisting of an oil in water emulsion, wherein the oil in water emulsion is comprising a plant protein and one or more hydrocolloids and a lipid phase in a water phase.

The frozen confection product of the present invention is non-dairy.

“Frozen,” as used herein, denotes that the product is solidified under freezing conditions to a hardpack or pumpable consistency, or a soft, semi-fluid, or spoonable consistency.

The protein used in the present invention is a plant protein. Plant protein can be selected from legume protein (e.g., pea, fava, soy, chickpea, lupin, mung bean, and lentil protein), cereal protein (e.g., corn, wheat, oat, barley, rice protein), pseudocereal protein (e.g., buckwheat, amaranth, quinoa), potato protein, water lentil protein, canola protein, sunflower protein, hemp protein and pumpkin protein.

In an aspect of the invention, the plant protein is pea protein.

The sweetener used in the present invention can be any sweetener that is commonly used in frozen confection product. It may be a natural or artificial sweetening agent.

Stabilizer and emulsifier have been used in an attempt to improve the heat shock stability, appearance and shelf life of the frozen confection product. Examples of stabilizers which have traditionally been used in frozen confection product such as ice cream include gum acacia, guar gum, locust bean gum, carob bean gum, carrageenan, and the like. Often microcrystalline cellulose and carboxymethylcellulose are used in combination with the previously mentioned gums to maximize their functional effectiveness, to reduce the degree of ice crystal growth by influencing viscosity and other rheological properties, thus limiting the mobility of water in the unfrozen aqueous portion.

Emulsifiers are the ones that are commonly used in frozen confection product and help providing stability by facilitating the formation of an interface between the aqueous phase and the fat phase. Examples of known emulsifiers include mono- and di-glycerides of saturated or unsaturated fatty acids (for example monoglyceryl palmitate), polyoxyethylene derivatives of hexahydric alcohols (usually sorbitol), glycols, glycol esters, polyglycerol esters, sorbitan esters, stearoyl lactylate, lactic acid esters, citric acid esters, acetylated monoglyceride, diacetyl tartaric acid esters, polyoxyethylene sorbitan esters, lecithin and egg yolk and mixtures thereof. Preferably the emulsifier is a mono-/di-glyceride of saturated fatty acids with a monoglyceride content of at least 40 percent.

Preferably the frozen confection product comprises at most 1 wt % (by weight of the product) emulsifier, at most 0.75 wt %, at most 0.5 wt %, at most 0.4 wt %, at most 0.3 wt %, at most 0.2 wt %, at most 0.1 wt %.

### Oil in Water Emulsion

Without being bound by any theory, the emulsion of the frozen confection product of the present invention is an oil-in-water emulsion whereby the water phase is the continuous phase wherein fine oil droplets of the vegetable fat/oil are dispersed. The oil in water emulsion is further comprising a plant protein and one or more hydrocolloids. Preferably, the protein is pea protein.

In one aspect of the invention, the one or more hydrocolloid present in the oil in water emulsion includes, but is not limited to gelatine, polymeric glycosaminoglycans such as e.g. hyaluronic acid, galactomannans, glucomannans, agar-agar, carrageenan, algin, carboxymethyl cellulose, pectin, amidated pectins, dextran, pullulan, xanthan gum, xyloglucans, native and modified starch, guar gum, locust bean gum, gellan gum, acacia gum, arabic gum, konjac gum, their derivatives, their corresponding salts and mixtures of two or more thereof. As before, the term carrageenan includes any of the three commercial classes of carrageenan: Kappa, lota and Lambda. The term galactomannan includes, without limitation, polymers having mannose:galactose ratios of 1:1, 2:1, 3:1, 4:1, 5:1 such as fenugreek gum, (mannose:galactose ratio of ca. ~1:1), guar gum (mannose:galactose ratio of ca. 2:1), tara gum (mannose:galactose ratio of ca. 3:1), locust bean gum or carob gum (mannose:galactose ratio of ca. 4:1) or cassia gum (mannose:galactose ratio of ca. 5:1). Suitable sources of galactomannan include, without limitation, konjac root, konjac powder, konjac flour, konjac fiber, mucilage or salep powder. In one aspect of the invention the one or more hydrocolloid is selected from xanthan gum, guar gum, locust bean gum, konjac gum, alginate, pectin, gellan gum, agar agar, or combinations of two or more thereof.

In one aspect of the invention the hydrocolloids in the oil in water emulsion are konjac fiber and agar agar.

The lipid phase of the oil in water emulsion is a vegetable oil.

The vegetable oil that is used in the present invention may be derived from one or more vegetable sources and may include oils and/or fats from a single origin or blends of two or more oils and/or fats from different sources or with different characteristics. They may be derived from standard oils or from specialty oils such as oils that have been subjected to fractionation and so on.

Examples of vegetable oils are amongst others, camelina oil, canola oil, cocoa butter, coconut oil, cottonseed oil, corn oil, groundnut oil, linseed oil, olive oil, palm oil, palm kernel oil, peanut oil, rapeseed oil, rice bran oil, sesame oil, safflower oil, shea butter, soy bean oil, sunflower oil, single or multiple fractionated oils, such as stearin and/or olein fractions, oil from any variety of oilseeds with increased level of unsaturated fatty acids compared to the original seed variety, such as mid or high oleic sunflower oil. These varieties with increased levels of unsaturated fatty acids can be obtained by natural selection or by genetic modification (GMO). Preferably, the vegetable oil is selected from the group consisting of cottonseed oil, corn oil, groundnut oil, linseed oil, olive oil, rapeseed oil, rice bran oil, sesame oil, safflower oil, soybean oil, sunflower oil, their corresponding high oleic varieties, and mixture of two or more thereof. More preferably, the vegetable oil is selected from the group consisting of corn oil, rapeseed oil, soybean oil, sunflower oil, their corresponding high oleic varieties, and mixture of two or more thereof. The high oleic varieties are containing at least 40%, at least 50%, at least 60%, at least 70% and preferably at least 80% oleic acid in respect of the fatty acid profile.

In one aspect of the invention, the vegetable oil of the oil in water emulsion is derived from sunflower oil.

The oil in water emulsion used in the present invention may further comprise acidulants such as citric acid and the like.

The oil in water emulsion can be prepared according to the method provided in WO 2021/219845 wherein the oil in water emulsion is described as a structured oil.

In one aspect of the invention, the oil in water emulsion is in solid gelled form.

In an aspect of the invention, the frozen confection product is comprising the oil in water emulsion in an amount of 2 to 30 wt % based on the weight of the frozen confection product.

In an aspect of the invention, the frozen confection product is comprising:
2.0 to 30 wt % oil in water emulsion
0.5 to 6 wt % protein
10 to 30% sweetener
0.1 to 1 wt % emulsifier, and
0.1 to 1 wt % stabilizer, based on the weight of the frozen confection product, and
   wherein the oil in water emulsion is comprising a protein and one or more hydrocolloids and a lipid phase in a water phase. The balance (to 100%) is water and/or plant-based milk such as almond milk, soy milk, sunflower mil, oat milk and the like.

In an aspect, the frozen confection product of the present invention is prepared by adding the oil in water emulsion to frozen confection product ingredients and wherein oil in water emulsion is comprising a plant protein and one or more hydrocolloids and a lipid phase in a water phase.

The frozen confection product ingredients are the ingredients mentioned before, such as protein, sweetener, emulsifier, stabilizer, and water and/or plant-based milk such as almond milk.

The frozen confection product of the present invention is selected from alternatives for ice cream, frozen custard, ice milk, sherbet, water ices, mellorine, frozen desserts for special dietary purposes, dairy bars, frozen mousse desserts.

The frozen confection product of the present invention is selected from alternatives for ice cream, frozen custard, ice milk, sherbet, mellorine, dessert bars, frozen mousse desserts.

The principal frozen confection products are ice cream alternative, frozen custard alternative, ice milk alternative, sherbet alternative and water ice alternative. In an aspect of the invention, the frozen confection product is free of dairy components and is non-dairy.

In one aspect of the invention, the frozen confection product is ice cream alternative or mellorine alternative.

Ice cream has a high fat content, ranging from 5% percent, up to 16% for so-called premium ice cream.

Frozen custard, or French ice cream, is basically the same formula as ice cream but contains added eggs or egg solids (usually 1.4 percent by weight).

Non-dairy Ice milk may be more commonly called “light” or “reduced-fat” ice cream. It contains between 2 and 7 percent fat.

Sherbet contains considerably more sugar and less air than ice cream (the target overrun is 30 to 40 percent), and therefore it is heavier and often contains more calories per serving.

Water ices are similar to sherbet, and have a target overrun of 20 to 30 percent.

Mellorine is in some parts of the United States and other countries another word for ice cream.

Frozen dessert bar may be an ice cream or mellorine filling coated with chocolate and/or wafer.

Frozen mousse is a frozen dessert of a frothy texture, made of sweetened and flavored whipped cream, sometimes with the addition of egg yolks and gelatine. Mousse differs from ice cream in being beaten before—not during—the freezing process.

In one aspect of the invention, the frozen confection product is ice cream alternative or mellorine alternative wherein the the oil in water emulsion is comprising a plant protein and one or more hydrocolloids and a lipid phase in a water phase.

A typical way to access the quality of frozen confection product is done by measuring its overrun. Overrun refers to the degree of expansion resulting from the amount of air incorporated into the product during the freezing process. An overrun of around 100% indicates that air makes up 50% of its volume.

Overrun is defined by the formula:

overrun (%)=(weight of mix−weight of aerated product)/(weight of aerated product)×100, where the weights refer to a fixed volume of mix or product. Overrun is measured at atmospheric pressure.

The frozen confection product may be aerated or unaerated. By unaerated is meant an overrun of less than 20%, preferably less than 10%. An unaerated frozen confection is not subjected to deliberate steps such as whipping to increase the gas content. Preferably the frozen confection product is aerated. Aerated frozen confection products have an overrun of more than 20%, preferably more than 50%, or more than 75%, Preferably the frozen confection product has an overrun of less than 200%, less than 150%, or less than 120%.

In one aspect of the invention, overrun for the alternatives for ice cream, and non-dairy ice milk may be 20 to 100 percent. Premium ice cream alternatives may be as low as 20 percent overrun, while soft ice cream alternatives are in the 30 to 50 percent range.

In one aspect of the invention the frozen confection product of the present invention has an overrun of from 20% to 60%.

In one aspect of the invention the frozen confection product of the present invention has an overrun of from 30% to 45%.

The present invention further relates to a process for preparing the frozen confection product of the invention and the process is comprising:
Blending oil in water emulsion with frozen confection product ingredients,
Freezing the blend, and
Wherein the oil in water emulsion is comprising a protein and one or more hydrocolloids and a lipid phase in a water phase.

Usually, the first step in making ice cream alternatives is formulating a suitable mix. The mix is composed of the frozen confection product ingredients such as protein, sweetener, emulsifier, stabilizer and oil in water emulsion. As mentioned before, the stabilizers and emulsifiers are added in small amounts to help prevent formation of ice crystals, particularly during temperature fluctuations in storage.

The ice cream alternative mix is heated to a temperature of at least 80 to 85 °C. The heated mix is typically homogenized in order to assure a smoother body and texture. Homogenizing also prevents churning (i.e., separating out of fat granules) of the mix in the freezer and increases the viscosity.

After homogenization, the hot mix is quickly cooled to below 5 °C. The mix must age at chilling conditions for at least four hours up to 24 hours to allow the fat to solidify and fat globules to clump. This aging process results in quicker freezing and a smoother product.

The next step, adding flavors where needed and freezing the mix, to freeze the product partially and, at the same time, incorporate air.

Semi frozen ice cream alternative leaves the freezer at a temperature between-9 and −5 °C. It is placed in a suitable container and conveyed to a blast freezer, where temperatures are in the range of −29 to −38 °C. While in this room, the ice cream continues to freeze without agitation. Rapid freezing at this stage prevents the formation of large ice crystals and favours a smooth body and texture. The length of time in the hardening room depends on the size of the package, but usually 4 to 12 hours are required to bring the internal ice cream temperature to −18 °C or below. In larger manufacturing plants, final freezing takes place in a hardening tunnel, where packages are automatically conveyed on a continuous belt to the final storage area.

Furthermore, the present invention relates to the frozen confection product obtainable by the process of the current invention.

The present invention further relates to a use of an oil in water emulsion to reduce the saturated fat content of a frozen confection product, and wherein the oil in water emulsion is comprising a protein and one or more hydrocolloids and a lipid phase in a water phase.

In one aspect, it relates to the use wherein the oil in water emulsion is present in the frozen confection product in an amount of 2 to 30% based on the weight of the frozen confection product.

In an aspect of the invention, the use allows for a reduction of the saturated fat content with at least 30%, per serving.

In an aspect of the invention, the use allows for a reduction of the saturated fat content of up to 80%, per serving.

In one aspect of the invention the use allows for a reduction of the total fat of at least 30% per serving, even up to 70% per serving.

It has been found that the frozen confection product according to the present invention, has sensory (creaminess and melt) and nutritional (total fat and calorie reduction, saturated fat content) benefits without negative impact on processing, and has improving overrun.

### CLAUSES

1. A frozen confection comprising plant protein, sweetener, emulsifier, stabilizer and an oil in water emulsion, wherein the oil in water emulsion is comprising a plant protein and one or more hydrocolloids and a lipid phase in a water phase.
2. The frozen confection product according to clause 1 wherein the oil in water emulsion is in solid gelled form.
3. The frozen confection product according to any one of the preceding clauses wherein the one or more hydrocolloids in the oil in water emulsion is selected from xanthan gum, agar-agar, locust bean gum, konjac gum, konjac powder, konjac vegetable fiber and glucomannan or mixtures of two or more thereof, preferably the one or more hydrocolloids in the oil in water emulsion are konjac fiber and agar agar.
4. The frozen confection product according to any one of the preceding clauses wherein the protein of the oil in water emulsion is pea protein.
5. The frozen confection product according to any one of the preceding clauses, wherein the lipid phase of the oil in water emulsion is a vegetable oil.
6. The frozen confection product according to any one of the preceding clauses, wherein the lipid phase of the oil in water emulsion is derived from sunflower oil.
7. The frozen confection product according to anyone of the preceding clauses wherein the oil in water emulsion is present in an amount of 2 to 30% based on the weight of the frozen confection product.
8. The frozen confection product according to anyone of the preceding clauses wherein the frozen confection product is comprising
   2.0 to 30 wt % oil in water emulsion
   0.5 to 4 wt % protein
   10 to 30% sweetener
   0.1 to 1 wt % emulsifier, and
   0.1 to 1 wt % stabilizer, based on the weight of the frozen confection product, and wherein the the oil in water emulsion is comprising a protein and one or more hydrocolloids and a lipid phase in a water phase.
9. The frozen confection product according to anyone of the preceding clauses wherein the frozen confection product is selected from alternatives for ice cream, frozen custard, ice milk, sherbet, water ices, mellorine, frozen desserts for special dietary purposes, dessert bars, frozen mousse desserts.
10. The frozen confection product according to anyone of the preceding clauses wherein the frozen confection product is ice cream alternative or mellorine alternative.
11. A frozen confection product prepared by adding an oil in water emulsion to frozen confection product ingredients and wherein the oil in water emulsion is comprising a plant protein and one or more hydrocolloids and a lipid phase in a water phase.
12. The frozen confection product according to clause 11 wherein the oil in water emulsion is in solid gelled form.
13. The frozen confection product according to any one of the clauses 11 or 12 wherein the one or more hydrocolloids in the oil in water emulsion is selected from xanthan gum, agar-agar, locust bean gum, konjac gum, konjac powder, konjac vegetable fiber and glucomannan or mixtures of two or more thereof, preferably the one or more hydrocolloids in the oil in water emulsion are konjac fiber and agar agar.
14. The frozen confection product according to any one of the clauses 11 to 13 wherein the protein of the oil in water emulsion is pea protein.
15. The frozen confection product according to any one of the clauses 11 to 14, wherein the lipid phase of the oil in water emulsion is a vegetable oil.
16. The frozen confection product according to any one of the clauses 11 to 15, wherein the lipid phase of the oil in water emulsion is derived from sunflower oil.
17. The frozen confection product according to anyone of the clauses 11 to 16 wherein the oil in water emulsion is present in an amount of 2 to 30 wt % based on the weight of the frozen confection product.
18. The frozen confection product according to anyone of the clauses 11 to 17 wherein the frozen confection product is comprising
   2.0 to 30 wt % oil in water emulsion
   0.5 to 4 wt % protein
   10 to 30% sweetener
   0.1 to 1 wt % emulsifier, and
   0.1 to 1 wt % stabilizer, based on the weight of the frozen confection product, and wherein the the oil in water emulsion is comprising a plant protein and one or more hydrocolloids and a lipid phase in a water phase.
19. The frozen confection product according to anyone of the clauses 11 to 18 wherein the frozen confection product is selected from alternatives for ice cream, frozen custard, ice milk, sherbet, water ices, mellorine, frozen desserts for special dietary purposes, dessert bars, frozen mousse desserts.
20. The frozen confection product according to anyone of the clauses 11 to 19 wherein the frozen confection product is ice cream alternative or mellorine alternative.
21. A process for preparing the frozen confection product according to anyone of clauses 1 to 20 and the process is comprising:
   Blending an oil in water emulsion with frozen confection product ingredients
   Freezing the blend
   Wherein the oil in water emulsion is comprising a plant protein and one or more hydrocolloids and a lipid phase in a water phase.
22. The process according to clause 21 wherein the oil in water emulsion is present in an amount of 2 to 30 wt % based on the weight of the frozen confection product.
23. The process according to clause 21 or 22 wherein the frozen confection product is comprising
   2.0 to 30 wt % oil in water emulsion
   0.5 to 4 wt % protein
   10 to 30% sweetener
   0.1 to 1 wt % emulsifier, and
   0.1 to 1 wt % stabilizer, based on the weight of the frozen confection product, and wherein the oil in water emulsion is comprising a protein and one or more hydrocolloids and a lipid phase in a water phase.
24. The process according to any one of clauses 21 to 23 wherein the oil in water emulsion is provided in solid gelled form.
25. The process according to any one of clauses 21 to 24, wherein the hydrocolloid in the oil in water emulsion is selected from xanthan gum, agar-agar, locust bean gum, konjac gum, konjac powder, konjac vegetable fiber and glucomannan or mixtures of two or more thereof, preferably the one or more hydrocolloids in the oil in water emulsion are konjac fiber and agar agar.
26. The process according to any one of the clauses 21 to 25 wherein the plant protein of the oil in water emulsion is pea protein.
27. The process according to any one of the clauses 21 to 26, wherein the lipid phase present in the oil in water emulsion is a vegetable oil.
28. The process according to any one of the clauses 21 to 27, wherein the lipid phase present in the oil in water emulsion is derived from sunflower oil.
29. Use of an oil in water emulsion to reduce the saturated fat content of a frozen confection product, and wherein the oil in water emulsion is comprising a plant protein and one or more hydrocolloids and a lipid phase in a water phase.
30. The use according to clause 29 wherein the oil in water emulsion is present in the frozen confection product in an amount of 2 to 30 wt % fat composition based on the weight of the frozen confection product.
31. The use according to any one of clauses 29 to 30 wherein the saturated fat content is reduced with at least 30% per serving.
32. The use according to anyone of clauses 29 to 31 wherein the saturated fat content is reduced with at least 50% per serving.
33. The use according to anyone of clauses 29 to 32 wherein the saturated fat content is reduced with at least 75% per serving.
34. The use according to anyone of clauses 29 to 33 wherein the saturated fat content is reduced up to 80% per serving.
35. The use according to anyone of clauses 29 to 34 wherein the total fat is reduced with at least 30% per serving,
36. The use according to anyone of clauses 29 to 35 wherein the total fat is reduced up to 70% per serving.

### EXAMPLES

### 1. Recipe of the Frozen Confection Product

The recipe of the frozen confection products are shown in table 1 and table 2.

TABLE 1
Recipe of the frozen confection product, ice
creamalternative Control (coconut oil)

| Ingredient | Weight % |
|---|---|
| Water | 8.52 |
| Liquid sugar, cane, 67.5 Brix | 17.8 |
| Coconut Oil | 4.3 |
| Unsweetened Almond Milk Shelf stable (USDA Generic) | 57.6 |
| Pea Protein (Puris Pea 870) | 4.1 |
| Spraydried Glucose Corn Syrup Solids C*Dry GL 01946 | 6.0 |
| Potassium sorbate, Sweetmix | 0.03 |
| Glycerin, 99.5% | 1.0 |
| Standard systems(Danitech XN FR 120)* | 0.65 |

*a blend of locust bean gum, guar gum, lecithin and salt to standardize

TABLE 2
Recipe of the frozen confection product, ice cream alternative
with oil in water emulsion, according to the invention.

| Ingredient | Weight % |
|---|---|
| Water | 7.5 |
| Liquid sugar, cane, 67.5 Brix | 18.0 |
| Oil in water emulsion (Go!Drop #21, containing 60% | 4.35 |
| sunflower oil) | |
| Unsweetened Almond Milk Shelf stable (USDA Generic) | 58.24 |
| Pea Protein (Puris Pea 870) | 4.15 |
| Spraydried Glucose Corn Syrup Solids C*Dry GL 01946 | 6.07 |
| Potassium sorbate, Sweetmix | 0.03 |
| Glycerin, 99.5% | 1.01 |
| Standard systems(Danitech XN FR 120)* | 0.66 |

*a blend of locust bean gum, guar gum, lecithin and salt to standardize

Go!Drop #21 is the oil in water emulsion provided by CUBIQ FOODS/Cargill and obtainable by the method described in patent application WO 2021/219845 and it is comprising water, refined sunflower oil, konjac vegetable fiber, pea protein, agar-agar and citric acid.

TABLE 3
Recipe of the frozen confection product, ice cream alternative
with oil in water emulsion, according to the invention.

| Ingredient | Weight % |
|---|---|
| Water | 7.5 |
| Liquid sugar, cane, 67.5 Brix | 18.0 |
| Oil in water emulsion (Go!Drop #38, contains 20% | 4.35 |
| sunflower oil) | |
| Unsweetened Almond Milk Shelf stable (USDA Generic) | 58.24 |
| Pea Protein (Puris Pea 870) | 4.15 |
| Spraydried Glucose Corn Syrup Solids C*Dry GL 01946 | 6.07 |
| Potassium sorbate, Sweetmix | 0.03 |
| Glycerin, 99.5% | 1.01 |
| Standard systems(Danitech XN FR 120)* | 0.66 |

*a blend of locust bean gum, guar gum, lecithin and salt to standardize

Go! Drop #38 is the oil in water emulsion provided by CUBIQ FOODS/Cargill and obtainable by the method described in patent application WO 2021/219845 and it is comprising water, refined sunflower oil, konjac vegetable fiber, pea protein, agar-agar and citric acid.

### 2. Preparation of the Frozen Confection Product, Ice Cream

The ice cream products were prepared according to the below procedure.

### Day 1

1. Weigh all the ingredients
2. Mix almond milk with pea protein
3. Add functional system (Hydrocolloids) and mix
4. Add potassium sorbate and mix
5. Add rest of dry ingredients (sugar, etc) and mix
6. Add glycerin and mix
7. Add oil in water emulsion (or in the control recipe the coconut oil) and mix
8. Homogenization and pasteurization
   1. Preheat at 60 °C.
   2. Heat at 85 °C for 30-60 s
   3. Cool down to 18 °C.

Rest overnight at chilling conditions (Aging)

### Day 2

1. Add flavors and mix. Rest for 1 hour.
2. Freezing
3. Packaging
4. Hardening −38 °C.
5. Storage in freezer.

### 3. Evaluation of the Frozen Confection Product, Ice Cream

### Characterization of Ice Cream

The characteristic properties are provided in Table 3.

TABLE 4

Overrun

| | | Ice cream according to invention, |
|---|---|---|
| Flavor | Control | including Go!Drop #38 |
| Honey Apricot | 35.42% | 40.39% |
| Caramel Coffee | 36.43% | 36.19% |

TABLE 5

| | Total | | | saturated |
|---|---|---|---|---|
| | fat | | total fat | fatty acids |
| | g/100 | | reduction vs | reduction vs |
| Fat system in ice | g ice | Saturated | coconut oil | coconut oil |
| cream | cream | fat | control (%) | control (%) |
| Coconut Oil (Control) | 5.85 | 4.11 | | |
| Go!Drop #11 | 5.01 | 0.65 | 14.36 | 84.15 |
| Go!Drop #38 | 2.37 | 0.59 | 59.49 | 85.76 |

### Sensory Evaluation

For the sensory evaluation expert panel 4-6 panelists have been used. The samples were tasted in 4-2 repetitions. For the serving procedure the samples were randomized with a 3-digit code and as quantity 1 jar of 120 ml frozen ice cream with a temperature of −13 °C served. On the testing protocol: the samples are swallowed and there was a break of 2 minutes between the samples. The order of serving was randomized and there were 2 products in one session evaluated.

TABLE 6

Tasting results

| | | |
|---|---|---|
| | | Ice cream according to invention |
| Flavor | Control | including Go!Drop #38 |

| | |
|---|---|
| Honey Apricot | Enhance flavor compared with |
| control | |
| Caramel Coffee | Enhance flavor compared with |
| control | |

1. A frozen confection product comprising plant protein, sweetener, emulsifier, stabilizer and fat, and the fat is consisting of an oil in water emulsion, wherein the oil in water emulsion is comprising a plant protein and one or more hydrocolloids and a lipid phase in a water phase.

2. The frozen confection product according to claim 1 wherein the lipid phase of the oil in water emulsion is a vegetable oil, preferably derived from sunflower oil.

3. The frozen confection product according to claim 1 wherein the one or more hydrocolloids in the oil in water emulsion is selected from xanthan gum, agar-agar, locust bean gum, konjac gum, konjac powder, konjac vegetable fiber and glucomannan or mixtures of two or more thereof, preferably the one or more hydrocolloids in the oil in water emulsion are konjac fiber and agar agar.

4. The frozen confection product according to claim 1 wherein the plant protein of the oil in water emulsion is pea protein.

5. A frozen confection product prepared by adding an oil in water emulsion to frozen confection product ingredients and wherein the the oil in water emulsion is comprising a plant protein and one or more hydrocolloids and a lipid phase in a water phase.

6. The frozen confection product according to claim 1 wherein the frozen confection product is selected from alternatives for ice cream, frozen custard, ice milk, sherbet, and water ices, mellorine, frozen desserts for special dietary purposes, dessert bars.

7. The frozen confection product according to claim 1 wherein the frozen confection product is selected from ice cream alternative and mellorine alternative.

8. The frozen confection product according to claim 1 wherein the oil in water emulsion is present in the frozen confection product in an amount of 2 to 30 wt % based on the weight of the frozen confection product.

9. A process for preparing the frozen confection product according to claim 1 the process is comprising:
Blending oil in water emulsion with frozen confection product ingredients,
Freezing the blend, and
Wherein the oil in water emulsion is comprising a plant protein and one or more hydrocolloids and a lipid phase in a water phase.

10. Use of an oil in water emulsion to reduce the saturated fat content of a frozen confection product, and wherein the oil in water emulsion is comprising a plant protein and one or more hydrocolloids and a lipid phase in a water phase.

11. The use according to claim 10 wherein the oil in water emulsion is present in the frozen confection product in an amount of 2 to 30 wt % based on the weight of the frozen confection product.

12. The use according to claim 10 wherein the saturated fat content is reduced with at least 30% per serving.

13. The frozen confection product according to claim 5 wherein the frozen confection product is selected from alternatives for ice cream, frozen custard, ice milk, sherbet, and water ices, mellorine, frozen desserts for special dietary purposes, dessert bars.

14. The frozen confection product according to claim 5 wherein the frozen confection product is selected from ice cream alternative and mellorine alternative.

15. The frozen confection product according to claim 5 wherein the oil in water emulsion is present in the frozen confection product in an amount of 2 to 30 wt % based on the weight of the frozen confection product.

16. A process for preparing the frozen confection product according to claim 5 the process is comprising:
Blending oil in water emulsion with frozen confection product ingredients,
Freezing the blend, and
Wherein the oil in water emulsion is comprising a plant protein and one or more hydrocolloids and a lipid phase in a water phase.
